(19) United States
(12) Patent Application Publication
(10) Pub. No.: US 2008/0159973 A1
(43) Pub. Date: Jul. 3, 2008

(54) Durable nail coating composition and method of use thereof

(76) Inventor: Quang V. Doan, Peachtree City, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/646,044

(22) Filed: Dec. 27, 2006

(51) Int. Cl. A61Q 3/02

(52) U.S. Cl. 424/61

(57) ABSTRACT

A durable nail coating composition comprising a one-to-one mixture of acrylic polymeric coatings, wherein the durable nail coating composition is applied to the portion of the nail extending forward of the fingertip. The durable nail coating composition is applied via a process that includes selectively installing a new nail set of tips to the natural nail, sizing the tips and selectively applying coatings that include the one-to-one mixture of acrylic polymers. Further, the durable nail coating is applied to a front portion of the nail to provide increased protection from damage with a gel coating subsequently coating the entire nail with or without added tips.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to methods and compositions for coating fingernails, and more specifically to a composition comprising a one-to-one mixture of two fingernail polymeric acrylic coatings into a durable nail coating composition and to a method for applying same.

2. Description of Related Art

Previous compositions have comprised monomeric oligomeric methacrylates in addition to fillers, initiators and activators. Such compositions, achieved by blending of copolymers, have been directed to providing a single coating material. In addition mixing of enamel components, including thixotropic agents, with various solvents has been utilized to provide for ease of application of the enamels and to control the rate of drying and hardening and thus the characteristics of the final film.

Additionally, providing a second coat of solid particles or a clear coat over a portion of the first code has been shown in the prior art. However, other previous methods of coating fingernails have relied on placing decorative coat on the nail. These methods were found deficient since the decorative coat was easily scratched, leading to rapid deterioration of the coat and subsequently unsatisfied clients. Further attempts were made by coating over the entire decorative coat with a secondary clear protective layer. However, in order for the clear protective layer to adequately cure, extensive time was required, often as long as eight minutes depending on the product applied and the strength and wavelength of the ultraviolet curing light. This long drying time is undesirable both for customers and for the nail shop owner since it reduces the throughput of customers in a shop. In addition to drying time, time is required for mixing of acrylic powders in solvent to prepare for application.

Unfortunately, these previous compositions and methods of application have resulted in a lesser quality coating that deteriorates rapidly, and customers of a nail shop have had to repeatedly return after only about two weeks to have their nails touched up or completely recoated. Further, with previous compositions and methods of application, nails have required removal of polish and a complete reapplication approximately every three months.

In addition to customer inconvenience, previous compositions (usually acrylic coatings) are typically of a toxic nature and require extensive use of cotton balls and acetone for removal and/or touch-up. Accordingly, spent waste toxins accumulate and must ultimately end up in a land fill, along with the cotton balls used to remove them. While being treated, the customer, and the person applying the nail coating, are subject to fumes from the noxious or toxic components. In addition to waste and vapors, the customer is in contact with toxic acrylic materials since these components are typically in direct contact with portions of the customer's natural nails, when applied in accordance with previous methods.

Although less toxic or noxious compositions are available, most persons applying nail coatings suffer from inertia when confronted with new and better products. If there is no other advantage, often new products will not be tried. Accordingly, only be providing additional advantages to the consumer, such as extended life and lower cost, will new technologies be utilized. Thus, it is customer demand that will drive applicators to try new methods, particularly if they last longer.

Therefore, it is readily apparent that there is a need for a durable nail coating composition and process of applying same, wherein the resulting durable nail coating last significantly longer, approximately twice as long or more, than previous products and application methods before requiring reapplication.

### BRIEF SUMMARY OF THE INVENTION

Briefly described, in a preferred embodiment, the present invention overcomes the above-mentioned disadvantages and meets the recognized need for such a device by providing a durable nail coating composition and method of application of same, wherein the durable nail coating composition is applied to either natural nails or artificial nail sets, and wherein the durable nail coating composition of the present invention typically lasts up to one year before requiring reconditioning and/or replacement.

Because of the much more durable coating of the present invention, repair and/or reapplication/recoating are much less frequent. Accordingly, the volume of waste toxic or noxious products, such as, for exemplary purposes only, acetone, and number of cotton balls used to apply removing materials, is reduced. In fact, the reduction is on the order of 90% for chemical components and 80% for cotton ball waste. This substantial reduction is due to reduced need for recoating the nails, which in turn, reduces the impact on workers and customers who are normally subject to repeated exposure to toxic or noxious materials.

The durable nail coating composition of the present invention comprises a one-to-one mixture of two component coating compositions. By combining the two coating compositions, a rugged coating is produced that can be quickly cured in three minutes or less, thereby reducing the amount of time needed to coat a customer's fingernails. While mixing of two components takes place in the present invention, it does not require the use of toxic or noxious solvents, as do previous methods.

According to its major aspects and broadly stated, the present invention in its preferred form is a durable nail coating composition and method of application of same, wherein the coating composition comprises a first component comprising urethane methacrylate oligomers, methacrylate monomers, silica, photoinitiators, and pigments Ext. D&C Violet No. 2 and titanium dioxide, and a second component comprising urethane acrylate oligomer, isobornyl methacrylate, trimethlolpropane trimethacrylate, hydroxycyclohexylphenyl ketone, polyester resin, silica, aluminum hydroxide, and pigment titanium dioxide.

The first component comprises a white gel-based paint that does not by itself adequately stand up to normal wear. The second component is a white gel that alone takes an excessively long time to cure, but which is very resistant to wear. It has been found that the one-to-one combination of the two components comprising the present invention results in a much shorter curing time on the order of three minutes, depending on the product and ultraviolet equipment.

The combination of components results in an easy to cure coating composition that is extremely durable. The coating composition is applied to the front portion of the nail that extends away from the tip of the finger. This durable coating composition protects this extended portion which typically receives the most wear and/or scratching or impact of objects thereon. By application of the durable coating composition of the present invention, this extended portion is better protected, thereby requiring less maintenance and/or less frequent replacement, saving customers several hundred dollars a year.

More specifically, the present invention is a durable nail coating comprising a mixture of nail coating components wherein the mixture is applied in lieu of application of a typical shiny top coat, such as, for exemplary purposes only, IBD Clear Gel (manufactured by American International Industries of Los Angeles, Calif.).

The method of application of the durable coating composition of the present invention begins with cleaning of the natural nails. If a new nail set is to be added, the extended tips are cut to length and then secured to the nail.

At this stage one of two typical coating methods, that is, application of a gel coat or application of an acrylic coat, may be selectively utilized. If the gel coat process is selected, the natural nails or nail tip combinations received a gel coat application which is subsequently cured. Excess gel is removed by alcohol, the nail is shaped, the nail around the cuticle is cleaned, and the nail is buffed. If the acrylic coating process is selected, an acrylic coat is applied, the nail is shaped, the nails are cleaned around the cuticle, the nails are buffed, and finally cuticle oil is applied and the hands are washed.

At this stage, whether a gel coat or acrylic coat is utilized, the nails receive a coating in the French or American style to the front portion of the nail. The coating may be airbrushed or hand applied. A smileline, or curved line, forms the innermost boundary of the coating and gives a clean delineation of the coated front portion of the nail.

Whichever process the nails have undergone, a shiny top coat, such as, for exemplary purposes only, SATION (manufactured by MISS Professional Nail Products, Inc. of Gardena; Calif.) may now be selectively applied, or alternately the durable nail coating composition of the present invention may be applied in lieu of the shiny top coat. Subsequent to either the application of the shiny top coat or of the durable nail coating composition of the present invention, the entire nail receives a coating of gel which is then UV cured. Any excess gel is removed with alcohol, cuticle oil is applied and the hands are washed.

Accordingly, a feature and advantage of the present invention is its ability to provide a long-lasting surface coating of fingernails.

Another feature and advantage of the present invention is its ability to prevent breakage of fingernails.

Still another feature and advantage of the present invention is its ability to be easily formulated in a small nail salon.

Yet another feature and advantage of the present invention is its rapid curing time.

Yet still another feature and advantage of the present invention is that it reduces solid and toxic waste products that must be disposed of in land fills.

Still a further feature and advantage of the present invention is that it reduces exposure of customers and workers to toxic and/or noxious chemicals.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 depicts a flow diagram detailing the steps for application of a gel coating to a fingernail according to a prior art process;

FIG. 2 is a flow diagram detailing the steps for application of an acrylic coating to a fingernail according to a second prior art process;

FIGS. 3A-3B depict a flow diagram detailing the steps for application of a gel coating to a fingernail according to an alternate embodiment of the present invention;

FIGS. 4A-B depict a flow diagram detailing the steps for application of an acrylic coating to a fingernail according to a preferred embodiment of the present invention;

FIG. 5 depicts a top view of a hand with fingernails having nail sets comprising tips attached to natural nails, and is common to all embodiments;

FIG. 6A is a side cutaway view showing coatings applied to fingernails according to a prior art gel coating process;

FIG. 6B is a top view depicting a fingernail according to a prior art gel coating process;

FIG. 7A shows a side cutaway view showing coatings applied to fingernails according to a prior art acrylic coating process;

FIG. 7B is a top view depicting a fingernail according to a prior art acrylic coating process;

FIG. 8A depicts a side cutaway view showing coatings applied to fingernails according to an alternate embodiment of a gel coating process of the present invention;

FIG. 8B shows a top view depicting a fingernail according to an alternate embodiment of a gel coating process of the present invention;

FIG. 9A is a side cutaway view showing coatings applied to fingernails via an acrylic coating process according to a preferred embodiment of the present invention; and

FIG. 9B is a top view depicting a fingernail according to a preferred embodiment of the present invention.

### DETAILED DESCRIPTION OF THE PREFERRED AND SELECTED ALTERNATIVE EMBODIMENTS

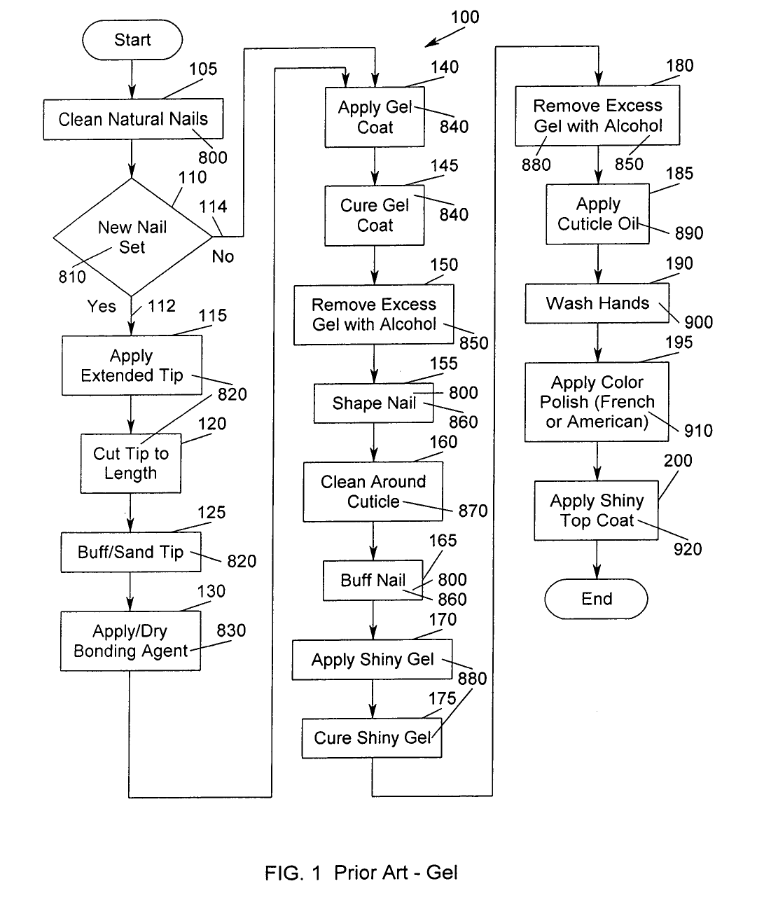

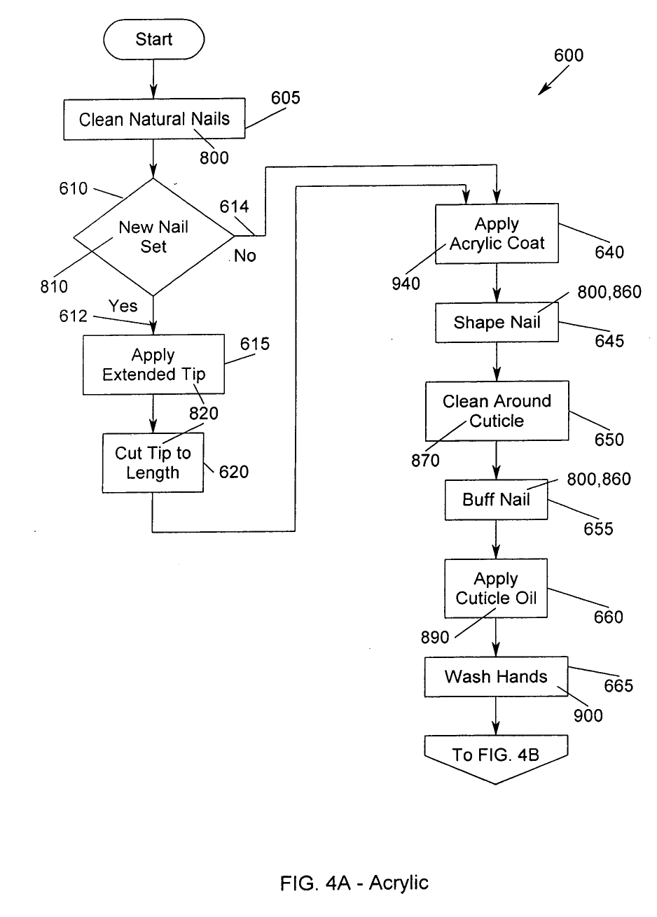

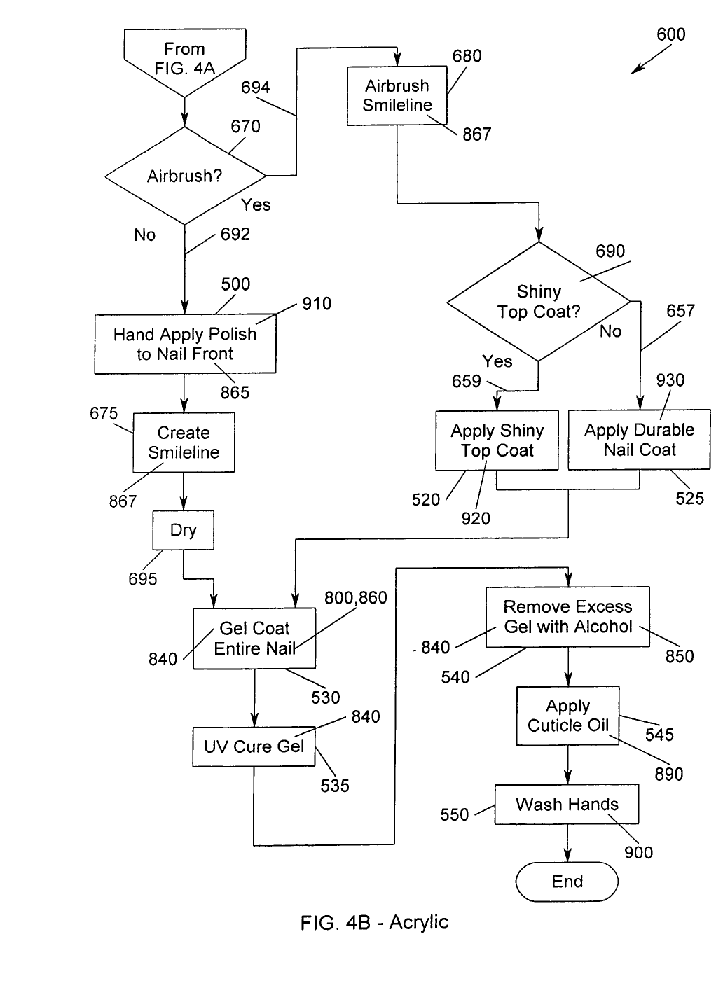

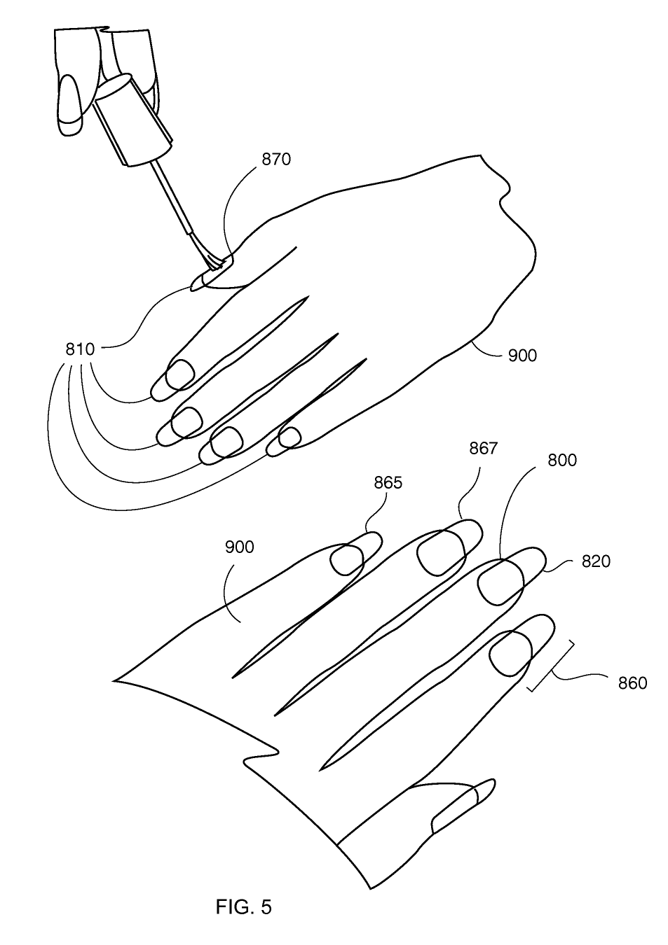

In describing the preferred and selected alternate embodiments of the present invention, as illustrated in FIGS. 1-9B, specific terminology is employed for the sake of clarity. The invention, however, is not intended to be limited to the specific terminology so selected, and it is to be understood that each specific element includes all technical equivalents that operate in a similar manner to accomplish similar functions.

Referring now particularly to FIGS. 1, 5, 6A and 6B, depicted therein is prior art process 100 for application of gel 840 to nails 800. Gel 840 comprises a gel coating material, such as, for exemplary purposes only, IBD Clear Gel (manufactured by American International Industries of Los Angeles, Calif.). Process 100 begins via step 105, wherein natural nails 800 are cleaned, and sanded and/or buffed to remove the shine and to roughen the texture for better adhesion of coatings. Subsequently, decision 110 is made whether or not to apply new nail set 810.

If decision 110 is negative via path 114, process 100 continues via step 140, wherein gel 840 is applied to entire surface of natural nails 800. Thickness of the nail may be built up by application of several thin coats or, alternately, via a single thick coat. Subsequently, gel 840 is cured via step 145, such as, for exemplary purposes only, by thermal or ultraviolet (UV) radiation. After coating of all natural nails 800, excess gel 840 is removed with alcohol 850 via step 150. Natural nails 800 are subsequently shaped via step 155 and nail at cuticle 870 is cleaned in step 160. Natural nails 800 are next buffed via step 165.

If decision 110 is affirmative via path 112, extended nail tips 820 are applied to natural nails 800 via step 115 and secured with glue. After application, tips 820 are cut to length via step 120 and again buffed or sanded to roughen the surface via step 125. Next, bonding agent 830, comprised of, for exemplary purposes only, BONDEX acrylic primer (manufactured by 1999 OPI Products Inc. of North Hollywood, Calif.) is applied to exposed portion 812 of natural nails 800 in step 130, and subsequently dried.

Following application of tips 820 to nails 800, process 100 continues via step 140, wherein gel 840 is applied to entire nail/tip combination 860. Subsequently, gel 840 is cured via step 145, such as, for exemplary purposes only, by thermal or UV radiation. After coating of all nail/tip combinations 860, excess gel 840 is removed with alcohol 850 via step 150. Each nail/tip combination 860 is subsequently shaped via step 155 and nail at cuticle 870 is cleaned in step 160. Each nail/tip combination 860 is next buffed via step 165.

Process 100 subsequently continues for either natural nails 800 or nail/tip combinations 860 via step 170, wherein shiny gel 880 comprises, for exemplary purposes only, CLEAR GEL from IBD, American International Industries of Los Angeles, Calif., and is applied to natural nails 800 or nail/tip combinations 860, wherein shiny gel 880 is subsequently cured via step 175. Excess shiny gel 880 is removed via step 180 with alcohol 850. Cuticle oil 890 is next applied via step 185 and hands 900 are washed in step 190. Finally, color polish 910, such as, for exemplary purposes only, white nail polish available from 1999 OPI Products Inc. of North Hollywood, Calif., is applied via hand or airbrush to natural nails 800 or nail/tip combinations 860 via step 195 to correspond to either a French or American design (lighter shade than French), wherein only front 865 of natural nail 800 or nail/tip combination 860 is coated with color polish 910, and, finally, shiny topcoat 920, such as, for exemplary purposes only, SATION (manufactured by MISS Professional Nail Products, Inc. of Gardena, Calif.) is applied via step 200 over entire natural nail 800 or nail/tip combination 860, thereby completing process 100.

Unfortunately, notwithstanding the covering of the front 865 with both polish 910 and shiny topcoat 920 via prior art process 100, natural nails 800 or nail/tip combinations 860 are subject to flaking off of topcoat and/or polish 910, with rapid deterioration of appearance of the nail. Further, inadvertent contact of acetone, which is prevalent in a nail coating salon, to shiny topcoat 920 and/or polish 910, will typically result in smearing and/or removal of the coatings.

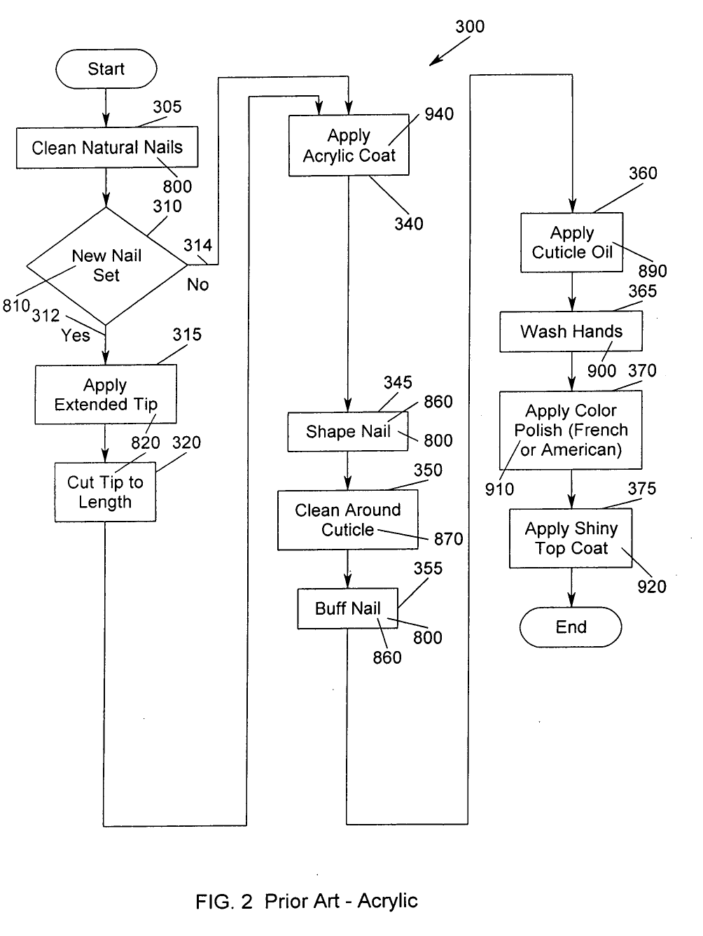

Referring now more particularly to FIGS. 2, 5, 7A and 7B, depicted therein is prior art process 300 for application of acrylic coating 940 (such as, for exemplary purposes only, airbrush acrylic water base as available from Holbein Works, Ltd. of Japan or acrylic powder mixed with acrylic liquid as available from OPI Products Inc. of North Hollywood, Calif.) to natural nails 800 or nail/tip combinations 860. Process 300 begins via step 305, wherein nails 800 are cleaned, sanded and/or buffed. Subsequently, decision 310 is made whether or not to apply new nail set 810.

If decision 310 is negative via path 314, process 300 continues via step 340, wherein acrylic coating 940 is applied to natural nails 800. After coating of all tips 820, nails 800 are subsequently shaped via step 345 and nail at cuticle 870 is cleaned in step 350. Natural nails 800 are next buffed via step 355.

If decision 310 is affirmative via path 312, extended tips 820 are applied via step 315. After application, tips 820 are cut to length via step 320. Process 300 continues via step 340, wherein following application of tips 820 to natural nails 800, acrylic coating 940 is applied to nail/tip combinations 860. After coating, nail/tip combination 860 is subsequently shaped via step 345 and nail at cuticle 870 is cleaned in step 350. Nail/tip combination 860 is next buffed via step 355.

For both natural nails 800 without added tips, or nail/tip combinations 860, process 300 subsequently continues via step 360, wherein cuticle oil 890 is next applied and hands 900 are washed in step 365. Finally, color polish 910 is applied via hand or airbrush to front 865 natural nails 800 or nail/tip combination 860 (if added) via step 370 to correspond to either a French or American design, and shiny topcoat 920 is applied via step 375, thereby completing process 300.

Again, even though front 865 is covered with polish 910 and/or shiny topcoat 920, coatings applied via process 300 suffer the disadvantages of flaking of topcoat 920 and/or polish 910, and subsequent necessity of repair and/or recoating of the nails with excessive frequency.

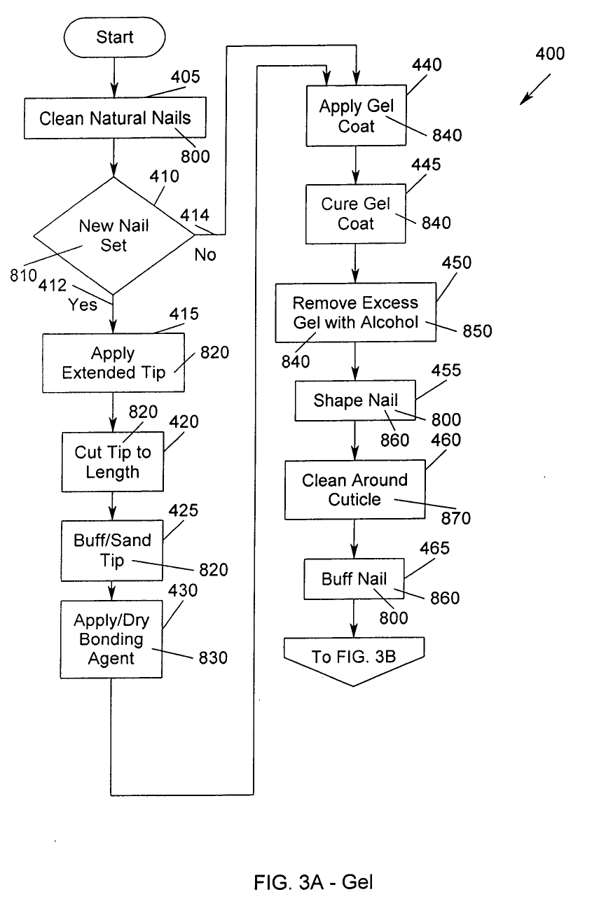

Referring now to FIGS. 3A, 3B, 5, 8A and 8B, depicted therein is alternate fingernail gel coating process 400 of the present invention, wherein gel coating process 400 overcomes the aforementioned disadvantages of prior art process 100 by providing a coating that lasts significantly longer before repair and/or replacement is required. Gel coating process 400 commences via step 405, wherein natural nails 800 are cleaned, sanded and/or buffed. Subsequently, decision 410 is made whether or not to apply new nail set 810.

If decision 410 is negative via path 414, process 400 continues via step 440 hereinbelow. If decision 410 is affirmative via path 412, extended tips 820 are applied via step 415, cut to length via step 420, and buffed/sanded in step 425. Bonding agent 830 is then applied to exposed portion 812 of natural nails 800 in step 430 and subsequently dried.

Gel 840 is next applied via step 440 over entire natural nail 800 or nail/tip combination 860. Gel 840 is subsequently cured via UV light in step 445. Excess gel 840 is removed with alcohol 850 via step 450, natural nails 800 or nail/tip combinations 860 are shaped via step 455, cuticle is cleaned via step 460, and natural nails 800 or nail/tip combinations 860 are buffed in step 465.

Process 400 continues via decision step 470 wherein a decision is made whether to airbrush the nail coating. If negative via path 492, polish 910 is hand applied in a French or American style to front 865 in step 500 and feathered in step 475 to provide a clean line, such as smileline 867. Polish 910 is next dried in step 495. Natural nails 800 or nail/tip combinations 860 are subsequently coated with gel 840 in step 530 as more fully described hereinbelow.

If the decision is positive via step 494 airbrushing of natural nails 800 or nail/tip combinations 860, as such is the case, commences in step 480, wherein a French or American style is applied to front 865 to create smileline 867. Subsequently, a decision is made in step 490 whether to use shiny top coat 920 or special durable nail coat 930. Durable nail coating composition 930 preferably comprises a one-to-one mixture of white gel paint 932 (sold by CREATIVE NAIL DESIGN, www.creativenaildesign.com, under the name BRISA CREATIVE) and white gel 934 (sold by IBD BEAUTY, www.ibdbeauty.com, under the name IBD FRENCH XTREME). White gel paint 932 preferably comprises urethane methacrylate oligomers, methacrylate monomers, silica, photoinitiators, and pigments Ext. D&C Violet No. 2 (Chemical Abstracts Service (CAS) No. c160730) and titanium dioxide (CAS No. c177891). White gel 934 comprises urethane acrylate oligomer, isobornyl methacrylate, trimethlolpropane trimethacrylate, hydroxycyclohexylphenyl ketone, polyester resin, silica, aluminum hydroxide (CAS No. c177002), and pigment titanium dioxide (CAS No. c177891).

If decision 490 is affirmative via path 459 to apply shiny top coat 920, shiny top coat 920 is applied via step 520 to front 865 of natural nails 800 or nail/tip combinations 860. If decision 490 is negative via path 457, special durable nail coat 930 is applied via step 525 to front 865 of natural nails 800 or nail/tip combinations 860.

After application of all selected coatings, process 400 continues via step 530 with application of gel 840, gel 840 is subsequently cured with ultraviolet light via step 535, excess gel 840 is removed via step 540 with alcohol 850, cuticle oil 890 is applied via step 545, and hands 900 are washed in step 550, thereby concluding process 400.

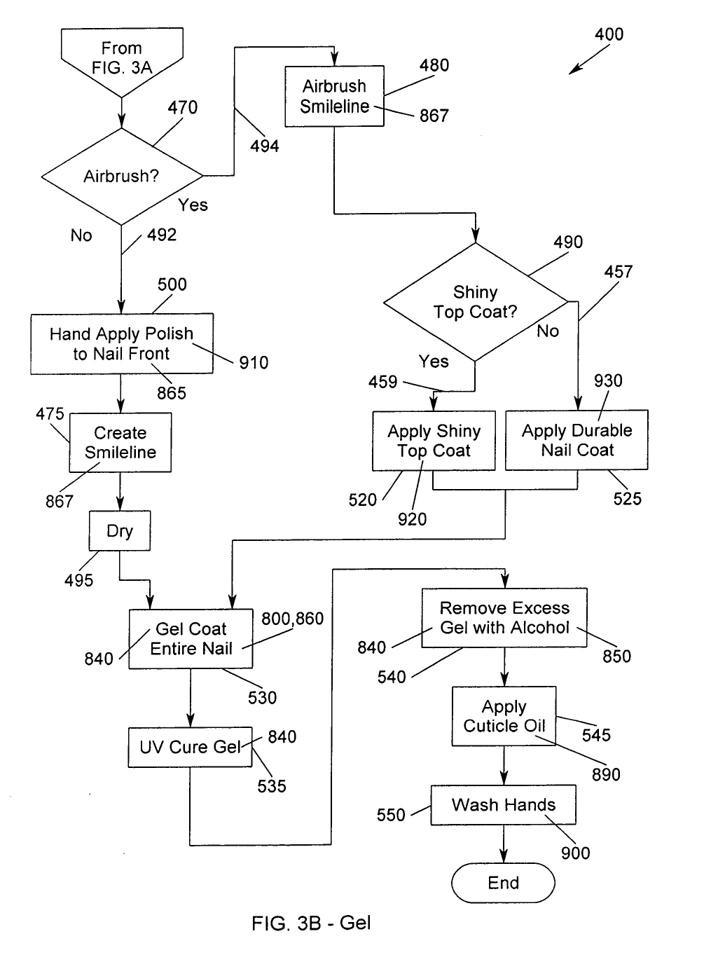

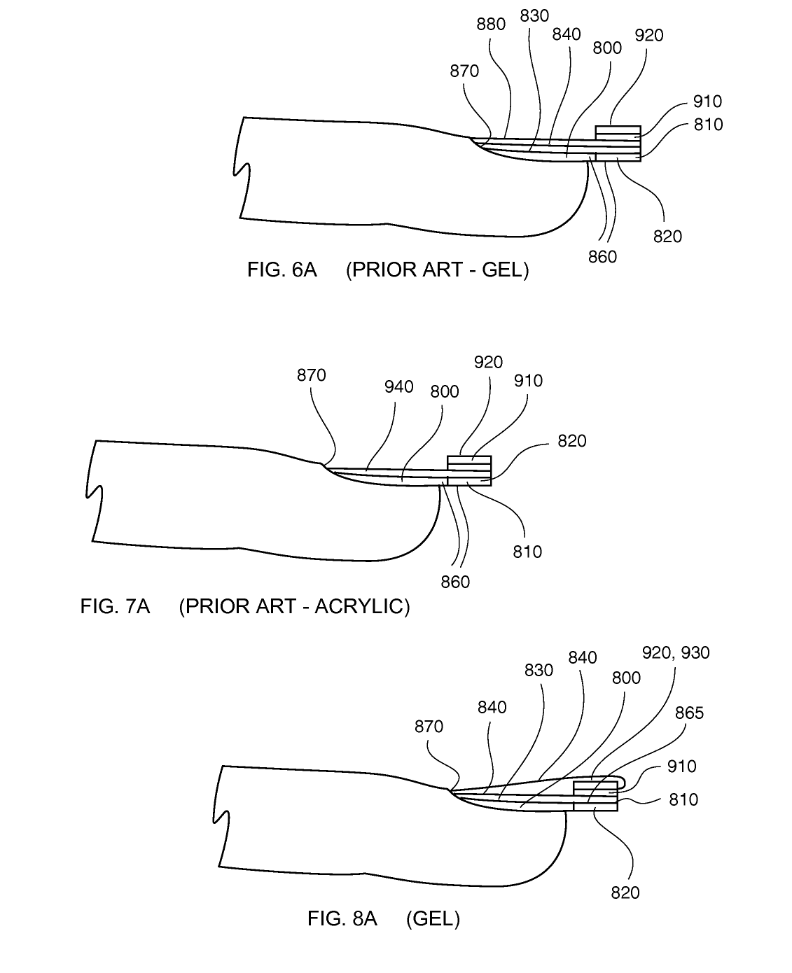

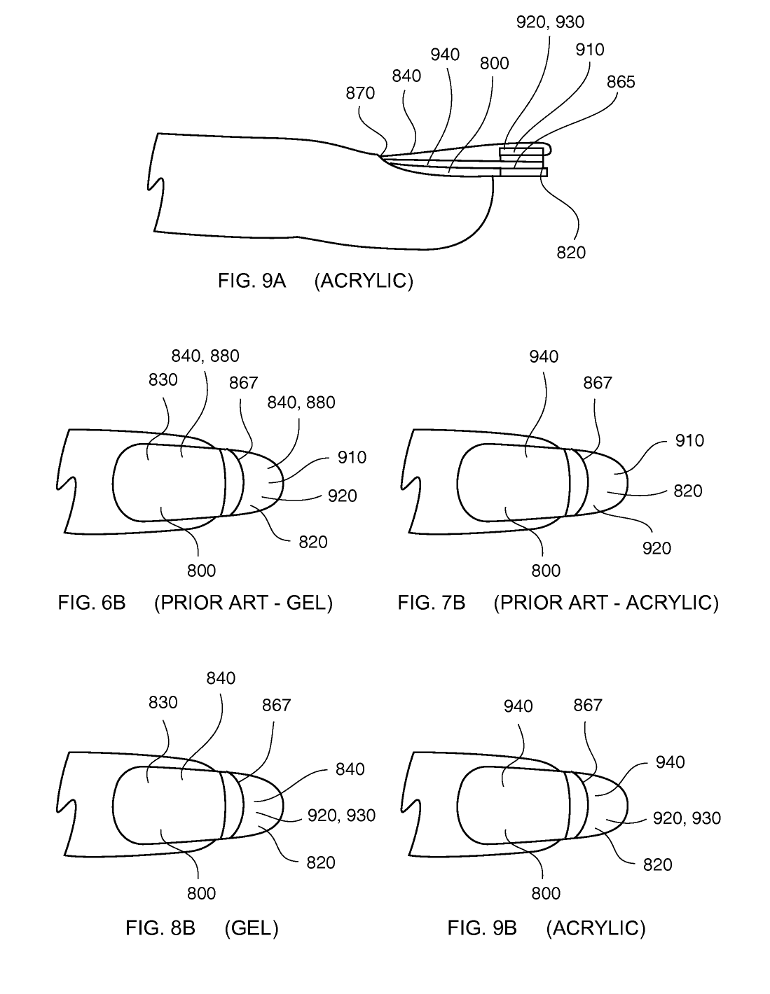

Referring now more specifically to FIGS. 4A, 4B, 5, 9A and 9B, illustrated therein is preferred embodiment comprising process 400, wherein the preferred embodiment of FIGS. 4A, 4B, 9A and 9B is substantially equivalent in form and function to that of the alternate embodiment detailed and illustrated in FIGS. 3A, 3B, 8A and 8B hereinabove except as hereinafter specifically referenced. Specifically, the embodiment of FIGS. 4A, 4B, 9A and 9B preferably comprises acrylic coating process 600, wherein acrylic coating process 600 overcomes the disadvantages of prior art process 300, providing substantially longer intervals between recoating and obviating the need fro repair. Acrylic coating process 600 preferably commences via step 605, wherein natural nails 800 are cleaned, sanded and/or buffed in step 605. Subsequently, decision 610 is preferably made whether or not to apply new nail set 810.

If decision 610 is negative via path 614, process 600 preferably continues via step 640 hereinbelow. If decision 610 is affirmative via path 612, extended tips 820 are preferably applied via step 615, and cut to length via step 620.

Acrylic 940 is preferably next applied via step 640 over entire natural nail 800 or nail/tip combination 860. Natural nails 800 or nail/tip combinations 860 are preferably shaped via step 645, cuticle 870 is preferably cleaned via step 650, natural nails 800 or nail/tip combinations 860 are preferably buffed in step 655, cuticle oil 890 is preferably applied via step 660 and hands 900 are preferably washed in step 665.

Process 600 continues via decision step 670 wherein a decision is preferably made whether to airbrush the nail coating. If decision step 670 is negative via path 692, polish 910 is preferably hand applied in a French or American style to front 865 in step 500 and preferably feathered in step 675 to provide a clean line, such as smileline 867. Polish 910 is next dried in step 695. Natural nails 800 or nail/tip combinations 860 are preferably subsequently coated with gel 840 in step 530 as more fully described hereinbelow.

If decision step 670 is positive via path 694, airbrushing of natural nails 800 or nail/tip combinations 860, as such is the case, preferably commences in step 680, wherein a French or American style is preferably applied to front 865 to form smileline 867. Subsequently, a decision is made in step 690 whether to use shiny top coat 920 or special durable nail coat 930. Durable nail coating composition 930 preferably comprises a one-to-one mixture of white gel paint 932 (sold by CREATIVE NAIL DESIGN, www.creativenaildesign.com, under the name BRISA CREATIVE) and white gel 934 (sold by IBD BEAUTY, www.ibdbeauty.com, under the name IBD FRENCH XTREME). White gel paint 932 preferably comprises urethane methacrylate oligomers, methacrylate monomers, silica, photoinitiators, and pigments Ext. D&C Violet No. 2 (Chemical Abstracts Service (CAS) No. c160730) and titanium dioxide (CAS No. c177891) White gel 934 preferably comprises urethane acrylate oligomer, isobornyl methacrylate, trimethlolpropane trimethacrylate, hydroxycyclohexylphenyl ketone, polyester resin, silica, aluminum hydroxide (CAS No. c177002), and pigment titanium dioxide (CAS No. c177891).

If decision 690 is affirmative via path 659 to apply shiny top coat 920, shiny top coat 920 is preferably applied via step 520 to front 865 of natural nails 800 or nail/tip combinations 860. If decision 690 is negative via path 657, special durable nail coat 930 is preferably applied via step 525 to front 865 of natural nails 800 or nail/tip combinations 860.

After application of all selected coatings, process 600 preferably continues via step 530 with application of gel 840, wherein gel 840 is preferably subsequently cured with ultraviolet light via step 535, excess gel 840 is preferably removed via step 540 with alcohol 850, cuticle oil 890 is preferably applied via step 545, and hands 900 are preferably washed in step 550, thereby concluding process 600.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method of coating fingernails, said method comprising the steps of:
applying a coating to the fingernails, wherein said coating is selected from the group consisting of a gel and an acrylic;
applying polish to a front portion of the fingernails via an application process selected from the group consisting of airbrush application and hand application; and
covering said front portion with a coating.

2. The method of claim 1, further comprising the step of:
optionally adding a new nail set to the natural nails.

3. The method of claim 2, wherein said step of optionally adding a new nail set further comprises the steps of:
applying extended tips; and
cutting said extended tips to length.

4. The method of claim 1, further comprising the step of:
applying a bonding agent to an exposed portion of the fingernails.

5. The method of claim 4, further comprising the step of:
coating the fingernails with a gel, including coating said exposed portion and said front portion.

6. The method of claim 1, further comprising the step of:
shaping the fingernail.

7. The method of claim 1, further comprising the step of:
buffing the fingernail.

8. The method of claim 1, further comprising the step of:
wherein said step of covering said front portion comprises covering said front portion with a durable nail coating composition.

9. The method of claim 8, wherein subsequent to said step of covering said front portion with a durable nail coating composition, said method further comprises the step of:
covering said durable nail coating composition with a gel coat.

10. The method of claim 9, further comprising the step of UV curing said second gel coat.

11. The method of claim 8, wherein said step of covering said front portion with a durable nail coating composition comprises the step of:
covering said front portion with a composition comprising a mixture of a first compound and a second compound, wherein said first compound comprises urethane methacrylate oligomers, methacrylate monomers, silica, photoinitiators, Ext. Violet 2 and titanium dioxide; and wherein said second compound comprises urethane acrylate oligomer, isobornyl methacrylate, trimethlolpropane trimethacrylate, hydroxycyclohexylphenyl ketone, polyester resin, silica, aluminum hydroxide, and titanium dioxide.

12. The method of claim 1, wherein said step of covering at least a portion of said gel with an additional coating comprises the step of:
covering a front portion of the fingernails.

13. A method of applying a coating to fingernails, said method comprising the steps of:
mixing a first compound and a second compound to form a durable nail coating composition, wherein said first compound comprises urethane methacrylate oligomers, methacrylate monomers, silica, photoinitiators, Ext. Violet 2 and titanium dioxide; and wherein said second compound comprises urethane acrylate oligomer, isobornyl methacrylate, trimethlolpropane trimethacrylate, hydroxycyclohexylphenyl ketone, polyester resin, silica, aluminum hydroxide, and titanium dioxide; and
applying said durable nail coating composition to the fingernails.

14. The method of claim 13, wherein said step of applying comprises the step of:
applying said durable nail coating composition to a front portion of the fingernails.

15. The method of claim 13, wherein prior to said step of applying, said method comprises the step of:
airbrushing a front portion of the fingernails.

16. The method of claim 13, wherein prior to said step of applying, said method comprises the step of:
hand applying polish to a front portion of the fingernails.

17. The method of claim 13, further comprising the step of:
coating said durable nail composition with a gel.

18. The method of claim 17, further comprising the step of:
UV curing said gel.

19. The method of claim 13, wherein prior to said step of applying, said method further comprises the step of:
coating the fingernails with an acrylic composition.

20. A fingernail coating composition comprising:
a mixture of a first compound and a second compound, wherein said first compound comprises urethane methacrylate oligomers, methacrylate monomers, silica, photoinitiators, Ext. Violet 2 and titanium dioxide; and wherein said second compound comprises urethane acrylate oligomer, isobornyl methacrylate, trimethlolpropane trimethacrylate, hydroxycyclohexylphenyl ketone, polyester resin, silica, aluminum hydroxide, and titanium dioxide.
